(19) United States
(12) Patent Application Publication
(10) Pub. No.: US 2014/0172585 A1
(43) Pub. Date: Jun. 19, 2014

(54) Advertising system to solve the problem of click fraud

(71) Applicant: Eric Michael Faccer, Brisbane (AU)

(72) Inventor: Eric Michael Faccer, Brisbane (AU)

(21) Appl. No.: 13/719,138

(22) Filed: Dec. 18, 2012

(51) Int. Cl. G06Q 30/02

(52) U.S. Cl. CPC G06Q 30/0273
USPC 705/14.69

(57) ABSTRACT

A process for an advertising system that transfers advertisements and commissions between merchants and advertisement presenters in a no-risk “payment on purchase” way, avoiding click fraud, is disclosed. The disclosed process allows merchants to set an amount of their profit margin for a product to be paid to the presenter of one of their advertisements only upon a consequent successful sale. Further, it allows advertisement presenters, content site owners, to directly select advertisements from a compiled list of advertisements ordered by margin. This allows content site owners to use their knowledge of their reader's purchase interests. The merchant pays the advertising system intermediary the decided margin upon a successful sale, and the advertising system pays the advertisement presenter. The advertising system's payment to the advertisement presenter is subject to a payment transfer function, which obscures the profit margin of the merchant to protect this information from competitors.

### CROSS-REFERENCE TO RELATED PATENT APPLICATION

Not Applicable

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### FIELD OF THE INVENTION

The current invention generally relates to connecting merchants with presenters of their advertisements.

### BACKGROUND OF THE INVENTION

Advertising is increasingly common in modern forms of media. In particular, on the World Wide Web, web sites and applications have an increasing desire to both present advertisements and to advertise their own content or products. This stems, as in traditional advertising, from two places: from a drive by merchants to use whatever media is available to them to advertise their product; and also from a drive by content owners to make money by presenting advertisements.

There are a number of existing advertising systems that connect the advertisements of merchants with content owners wishing to present advertisements. Modern interactive media, such as the World Wide Web, provide the opportunity for these advertising systems to be increasingly sophisticated. A number of systems, notably Google's AdSense, do not allow the advertisement presenter to choose their own ads, but rather use an algorithm to determine what advertisement is presented based on the content of the web site in which it is presented.

A user's history of activity on the World Wide Web can also be used, possibly along with the content of the web site, to better target an advertisement. Technologies in use on the World Wide Web, such as Flash cookies, HTTP cookies, Web Storage, and web bugs, allow such a profile of a user to compiled. This kind of advertisement targeting is generally more effective in terms of not showing advertisements for products a user does not want.

Despite the use of advertisement targeting, users are still being presented with advertisements for products they do not want. Such advertisements are a waste of the merchant's money, and a loss of revenue for the presenter of the advertisement if their arrangement is at all based on commission.

Furthermore, advertisement systems operating on the Internet suffer the problem of “click fraud”. Click fraud describes the situation where a merchant's competitors can click on all the merchant's advertisements, thus exhausting the merchant's marketing budget.

A good advertising system will increase the sales of the merchant and reward the advertisement presenter, increasing the revenue of both. Further, it will also eliminate or at least reduce the threat of click fraud. There is demand for such systems. A trusted intermediary, with access to merchants, content owners, and consumers, is ideally placed to offer such a system.

### BRIEF SUMMARY OF THE INVENTION

The present invention seeks to provide such a solution system. Disclosed is an invention for connecting merchants with presenters of their advertisements using an advertising system that solves the problem of click fraud.

According to a first aspect of the present invention, there is provided a method for the transfer of advertisements and commissions between merchants and advertisement presenters, the method comprising the steps of:
obtaining from a merchant an advertisement, and an amount of their profit margin they are willing to give up upon the advertisement resulting in a successful sale;
compiling a list of advertisements and making this list available to potential presenters of the advertisements;
providing a selected advertisement to a presenter of advertisements;
charging the merchant the decided profit margin upon the advertisement resulting in a successful sale; and
paying the advertisement presenter the decided profit margin less a specified payment calculation function.

According to another aspect of the present invention, there is provided an apparatus for the transfer of advertisements and commissions between merchants and advertisement presenters, the apparatus comprising:
memories for storing client programs;
memories for storing server programs;
client processors and server processors for executing the programs, said programs
   comprising:
code for obtaining from a merchant an advertisement, and an amount of their profit margin they are willing to give up upon the advertisement resulting in a successful sale;
code for compiling a list of advertisements and making this list available to potential presenters of the advertisements;
code for providing a selected advertisement to a presenter of advertisements;
code for charging the merchant the decided profit margin upon the advertisement resulting in a successful sale; and
code for paying the advertisement presenter the decided profit margin less a specified payment calculation function.

According to another aspect of the present invention, there is provided a computer program product including a computer readable storage medium having recorded thereon a computer program or programs for directing a server or client processor to execute a method the transfer of advertisements and commissions between merchants and advertisement presenters, said program comprising:
code for obtaining from a merchant an advertisement, and an amount of their profit margin they are willing to give up upon the advertisement resulting in a successful sale;
code for compiling a list of advertisements and making this list available to potential presenters of the advertisements;
code for providing a selected advertisement to a presenter of advertisements;
code for charging the merchant the decided profit margin upon the advertisement resulting in a successful sale; and
code for paying the advertisement presenter the decided profit margin less a specified payment calculation function.

Other aspects of the invention are also disclosed.

### BRIEF DESCRIPTION OF THE SEVERAL VIEWS OF THE DRAWING

One or more embodiments of the present invention will now be described with reference to the drawings, in which:

FIG. 1 is a flowchart of a process used for an advertising system that transfers advertisements and commissions between merchants and advertisement presenters in a no-risk “payment on purchase” way;

FIG. 2 shows a graphical depiction of the relationships between the consumer, the merchant, the advertisement presenter, and the intermediary; and

FIG. 3 is a block diagram of a computer network upon which the authentication method may take place.

### DETAILED DESCRIPTION OF THE INVENTION

Where reference is made in any one or more of the accompanying drawings to steps and/or features, which have the same reference numerals, those steps and/or features have for the purposes of this description the same function(s) or operation(s), unless the contrary intention appears.

As noted, the current invention generally relates to connecting merchants with presenters of their advertisements. From a terminology perspective, the term “merchant” refers to the entity wishing to advertise its products; the term “intermediary” refers to the provider of the advertising system of the present invention that connects merchants with advertisement presenters; the term “advertisement presenter” refers to the content owner who presents the advertisement on their web application or web site; and the term “consumer” refers to the target of the advertisement whom the merchant wishes to make purchase its product.

A process for an advertising system that transfers advertisements and commissions between merchants and advertisement presenters in a no-risk “payment on purchase” way, avoiding click fraud, is described below. The described process allows merchants to set an amount of their profit margin for a product to be paid to the presenter of one of their advertisements only upon a consequent successful sale. Further, it allows advertisement presenters, content site owners, to directly select advertisements from a compiled list of advertisements ordered by margin. This allows content site owners to use their knowledge of their reader's purchase interests. The merchant pays the advertising system intermediary the decided margin upon a successful sale, and the advertising system pays the advertisement presenter. The advertising system's payment to the advertisement presenter is subject to a payment transfer function, which obscures the profit margin of the merchant to protect this information from competitors.

The system will result in the merchant varying its decided margin relinquished for advertising to find that most economically efficient. Specifically, the merchant can use the system to maximize their supply rate into the general market by manipulating the margin they give away to affiliates and marketers, the advertisement presenters in the advertising system. Since advertisements in the system are risk free, this provides a useful tool for companies to find their global profit maximum.

Furthermore, the described process solves the problem of click fraud. A model based on cost per purchase (CPP), a variant of cost per action (CPA), only results in the transfer of money upon the merchant successfully selling a product. A competitor thus cannot exhaust the marketing budget of a merchant by clicking on a merchant's advertisements without making a purchase.

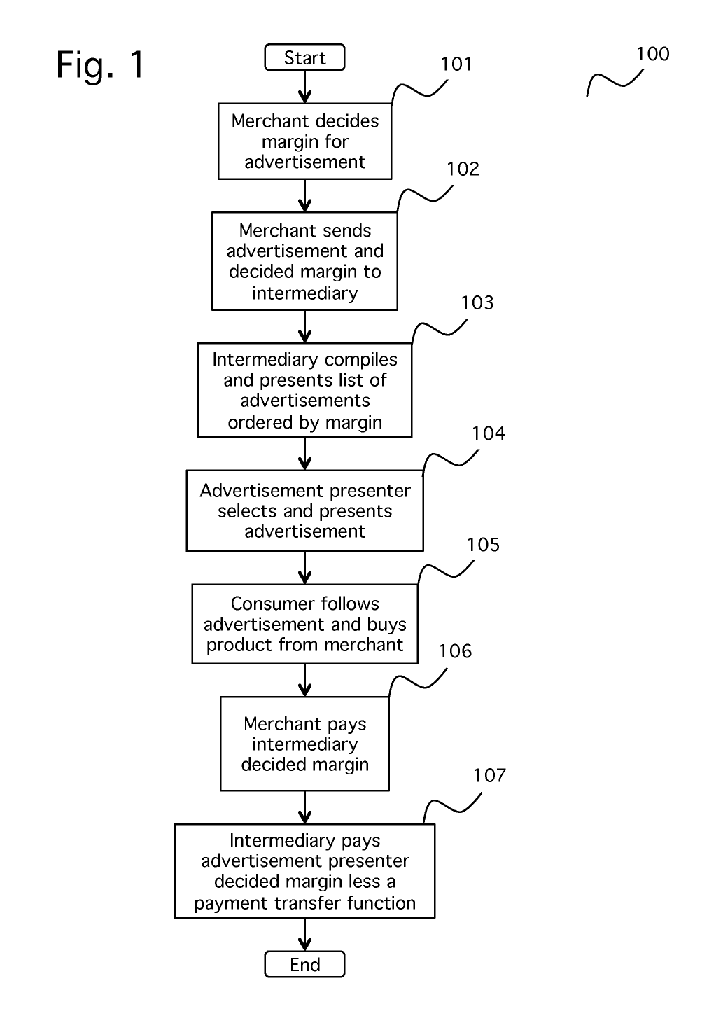

FIG. 1 is a flowchart of process 100 used for an advertising system that transfers advertisements and commissions between merchants and advertisement presenters in a no-risk “payment on purchase” way. The process 100 will now be described in detail with reference to FIG. 1. The process 100 begins at step 101. At step 101 in the present embodiment the merchant, who has an advertisement they wish to be presented, decides how much of their profit margin they wish to give up for an advertisement that results in the sale of their product. For example, if the merchant has a product on which they make a profit of $20, they may decide to relinquish a margin of $5 for advertising. At step 102 the merchant sends its advertisement and this decided margin to the trusted intermediary.

At step 103, the intermediary adds this advertisement to its pool of advertisements. In the present embodiment, when presented to potential advertisement presenters, the pool of advertisements is ordered by the decided margin. This pool of advertisements is available at any time to potential advertisement presenters. An example of such an advertisement presenter is an online news web site wishing to monetize their content.

At step 104, an advertisement presenter selects an advertisement to present from the ordered pool made available by the intermediary. Optionally, the potential presenter of the advertisement can choose to further refine the available pool of advertisements by a category of product. The ordered pool allows the choice of advertisement that is both best suited to the audience of the advertisement presenter, and which will be the most lucrative. Unlike a system where the intermediary chooses the advertisement, it allows the presenter of advertisements to directly use their knowledge of their audience. On the Internet, this knowledge is often particularly substantial since many technologies are available to collect web site statistics and build up profiles of visitors.

At step 105, a consumer presented with the advertisement is persuaded to purchase the product of the merchant. They follow the advertisement, which takes them to a purchase site of the merchant, and purchase the product. The consumer transfers payment for the product to the merchant, and the merchant sends the consumer the product. At step 106, the merchant then pays the intermediary the decided margin for a successful sale arising from the advertisement. Note that this only happens upon a product purchase and thus solves the problem of click fraud.

The process 100 ends at step 107. Here, the intermediary pays the presenter of the advertisement an amount equal to the decided margin less a payment calculation function. This payment calculation function comprises a compensation function and a fuzzing function. The compensation function determines the profit of the intermediary providing the advertising system. The fuzzing function is to prevent the advertisement presenter from directly discovering the decided margin of the merchant, and so to prevent competitors from directly obtaining profit margin information. In the current best mode, the compensation function is a simple percentage and the fuzzing function is a requirement for an advertisement presenter to have generated a specific number of sales of different products for a specific number of different merchants before the intermediary will transfer payment. Those skilled in the art will note that other fuzzing functions could be chosen to obscure profit information.

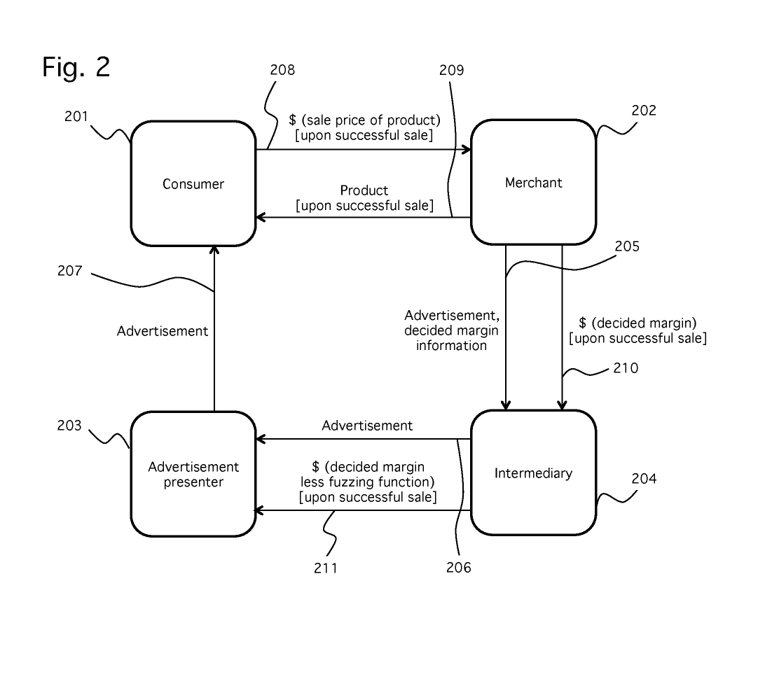

FIG. 2 shows a graphical depiction of the relationships between the consumer 201, the merchant 202, the advertisement presenter 203, and the intermediary 204. The merchant 202 sends the advertisement and decided margin information 205 to the intermediary 204 in step 102. The intermediary 204 sends this advertisement 206, selected from its pool, to the advertisement presenter 203 in step 104. Also in step 104, the advertisement presenter 203 presents this advertisement 207 to the consumer 201 on its web application or web site. The consumer 201 is persuaded by the advertisement to make a purchase 208 from the merchant 202 in step 105, and in turn the merchant 202 sends the product 209 to the consumer 201. The merchant 202 then pays 210 the intermediary 204 the decided margin following the successful sale in step 106. Finally, the intermediary 204 pays 211 the advertisement presenter 203 the decided margin less the payment calculation function in step 107. Not depicted in FIG. 2 is the information kept track of by the intermediary supplying the advertisements and providing the advertising system, which has knowledge of all of the transactions taking place. This knowledge is necessary for compliance with all of the agreed relationships. A trusted intermediary is thus ideally placed to provide such an advertising system.

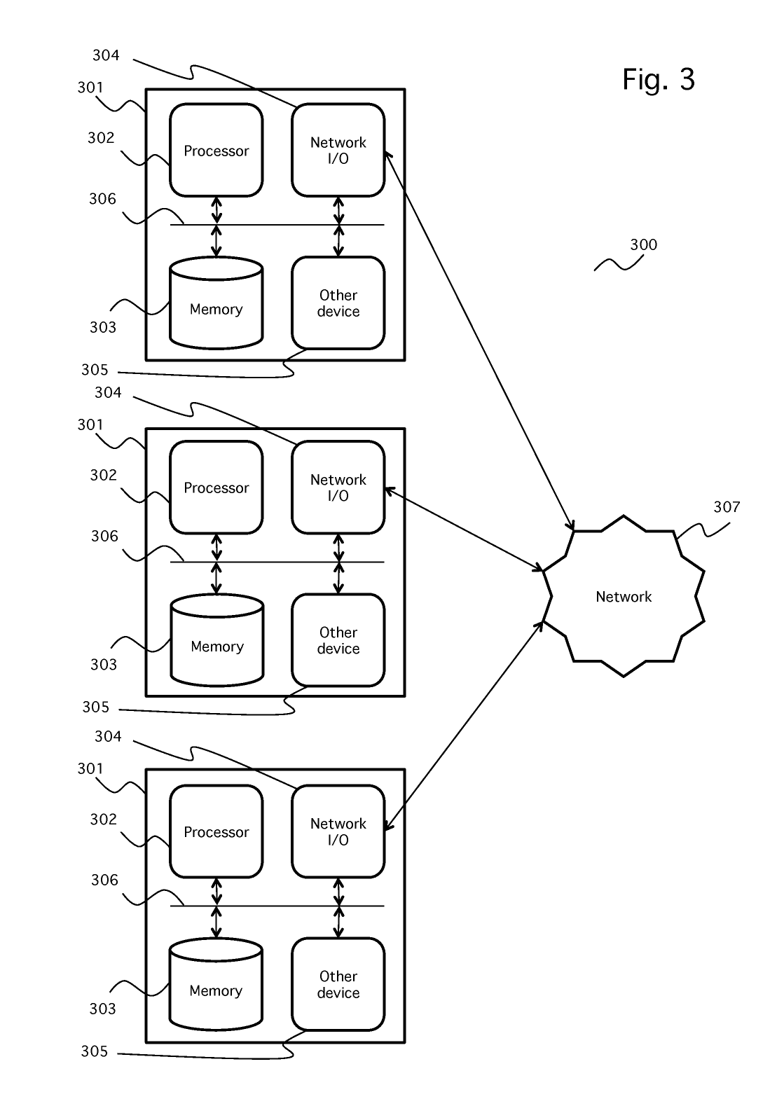

FIG. 3 is a block diagram of a computer network upon which the advertising system method may take place. The architecture depicted 300 consists of a number of computers 301 which may be clients or servers, connected to a network 307. In the best mode of the present embodiment, the network 307 is the Internet. The computers 301 connected to the network 307 may each be an entity of the advertising system: the merchant's 202 server running its sales site, the intermediary's 204 server serving the advertisement, the advertisement presenter's 203 content site, or the consumer's 201 computer being used for web browsing. These entities can all communicate through the network 307 to implement the disclosed advertising system of the present embodiment. The computers 301 may also be other unrelated computers also connected to the network. The block diagram's depiction of three computers 301 is not limiting and there is no limit to the number of connecting computers. Computers 301 include a processor 302, a computer readable medium 303, and a network input/output (I/O) device 304, such as a modem, able to connect the computer 301 through the network 307 with other computers. A computer may also include other devices 305 including, but not limited to, additional processors, additional hard drives, CD or DVD drives, other memory or storage, mice, keyboards, monitors, speakers, microphones, printers, scanners, or other input and/or output devices. The computer components 302, 303, 304, and 305 typically connect and communicate via a bus 306 in a manner that results in the usual operation of the computer 301 well known to those skilled in the art.

In a second embodiment, rather than the merchant providing an advertisement for a specific product and a decided margin to give up for that product, the merchant instead provides a more general advertisement for either a group of products, or for the merchant itself. In this case, the merchant can specify the decided margin for each possible product, or more likely, will set the decided margin as the floor commission offered to marketers. The reason the floor commission is the likely choice is because the marketer is doing less work, since they are only recommending a store rather than an actual product that meets the specific need of a consumer.

In a third embodiment, rather than the advertisement presenter relying upon their own knowledge and statistics of their content site's audience, they may ask the intermediary for an advertisement recommendation. This filters the pool of advertisements to those the intermediary recommends. The intermediary may use their knowledge of consumers' histories to recommend one or more advertisements. Such a recommendation may be made based off consumers' purchases or other interactions with the intermediary advertising system. Alternatively, a recommendation may also be supplemented with a range of techniques that exist to build up user profiles, well known to those skilled in the art and including technology such as Flash cookies, HTTP cookies, Web Storage, and web bugs.

The invention claimed is:

1. A method for the transfer of advertisements and commissions between merchants and advertisement presenters, the method comprising the steps of:
obtaining from a merchant an advertisement, and an amount of their profit margin they are willing to give up upon the advertisement resulting in a successful sale;
compiling a list of advertisements and making this list available to potential presenters of the advertisements;
providing a selected advertisement to a presenter of advertisements;
charging the merchant the decided profit margin upon the advertisement resulting in a successful sale; and
paying the advertisement presenter the decided profit margin less a specified payment calculation function.

2. A method according to claim 1, wherein said advertisement is any form of multimedia including:
an image without audio; a video without audio; an animation without audio; text without audio; an image with audio; a video with audio; an animation with audio; or text with audio.

3. A method according to claim 1, wherein said merchant is an online retailer.

4. A method according to claim 1, wherein said advertisement presenters are web applications, web pages, or other web sites.

5. A method according to claim 1, wherein said list of advertisements is ordered by the expected payment an advertisement presenter would receive upon a successful sale.

6. A method according to claim 1, wherein said list of advertisements can be searched by genre of products.

7. A method according to claim 1, wherein said list of advertisements can be filtered to recommendations.

8. A method according to claim 7, wherein said recommendations are based on the history of purchases and other interactions that consumers have had with the entity implementing the method.

9. A method according to claim 1, wherein said advertisement is an advertisement for a particular product of the merchant.

10. A method according to claim 1, wherein said advertisement is an advertisement for a plurality of products of the merchant.

11. A method according to claim 1, wherein said advertisement is an advertisement for the merchant itself and not a specific product.

12. A method according to claim 1, wherein said profit margin the merchant is willing to give up is the floor commission the merchant offers to marketers.

13. A method according to claim 1, wherein said payment calculation function comprises a compensation function and a fuzzing function.

14. A method according to claim 13, wherein said compensation function is the profit margin of the intermediary.

15. A method according to claim 13, wherein said fuzzing function is designed to obscure a specific product or merchant's profit margin.

16. A method according to claim 15, wherein said fuzzing function is a requirement for an advertisement presenter to have successfully advertised for a specified plurality of merchants and a specified plurality of products before receiving payment from the intermediary.

17. An apparatus for the transfer of advertisements and commissions between merchants and advertisement presenters, the apparatus comprising:
memories for storing client programs;
memories for storing server programs;
client processors and server processors for executing the programs, said programs comprising:
code for obtaining from a merchant an advertisement, and an amount of their profit margin they are willing to give up upon the advertisement resulting in a successful sale;
code for compiling a list of advertisements and making this list available to potential presenters of the advertisements;
code for providing a selected advertisement to a presenter of advertisements;
code for charging the merchant the decided profit margin upon the advertisement resulting in a successful sale; and
code for paying the advertisement presenter the decided profit margin less a specified payment calculation function.

18. A computer readable storage medium having recorded thereon a computer program or programs for directing a server or client processor to execute a method for the transfer of advertisements and commissions between merchants and advertisement presenters, said program comprising:
code for obtaining from a merchant an advertisement, and an amount of their profit margin they are willing to give up upon the advertisement resulting in a successful sale;
code for compiling a list of advertisements and making this list available to potential presenters of the advertisements;
code for providing a selected advertisement to a presenter of advertisements;
code for charging the merchant the decided profit margin upon the advertisement resulting in a successful sale; and
code for paying the advertisement presenter the decided profit margin less a specified payment calculation function.
